(19) United States
(12) Patent Application Publication
(10) Pub. No.: US 2002/0097902 A1
(43) Pub. Date: Jul. 25, 2002

(54) Method and system for the display of regions of interest in medical images

(76) Inventors: Jimmy R. Roehrig, Palo Alto, CA (US); Shih-Ping Wang, Los Altos, CA (US); Susan A. Wood, Mountain View, CA (US); Harlan M. Romsdahl, Half Moon Bay, CA (US); Julian Marshall, Los Altos, CA (US); Sandra Stapleton, Palo Alto, CA (US)

Correspondence Address: Pennie & Edmonds, LLP, 3300 Hillview Avenue, Palo Alto, CA, 94304, US

(21) Appl. No.: 09/990,508

(22) Filed: Nov. 21, 2001

Related U.S. Application Data
(63) Continuation-in-part of application No. 09/946,209, filed on Sep. 5, 2001.
Application No. 09/946,209 is a continuation-in-part of application No. 09/891,676, filed on Jun. 26, 2001.
Application No. 09/946,209 is a continuation-in-part of application No. 09/798,756, filed on Mar. 2, 2001.
Application No. 09/179,205 is a continuation-in-part of application No. 08/980,254, filed on Nov. 28, 1997, now abandoned.
Application No. 09/179,205 is a continuation-in-part of application No. 08/579,802, filed on Dec. 28, 1995, now Pat. No. 5,828,774.
Application No. 08/579,802 is a continuation of application No. 08/129,255, filed on Sep. 29, 1993, now abandoned.
Application No. 08/980,254 is a continuation-in-part of application No. 08/438,432, filed on May 10, 1995, now Pat. No. 5,729,620.
Application No. 08/438,432 is a continuation-in-part of application No. 08/129,255, filed on Sep. 29, 1993, now abandoned.
(60) Provisional application No. 60/252,775, filed on Nov. 22, 2000.

(51) Int. Cl. G06K 9/00

(52) U.S. Cl. 382/132

(57) ABSTRACT

A computer-aided diagnostic (CAD) method and system provide image annotation information that can include an assessment of the probability, likelihood or predictive value of the CAD-detected suspected abnormalities as an additional aid to the radiologist. More specifically, probability values, in numerical form and/or analog form, are added to the locational markers of the CAD-detected suspected abnormalities. The task of a physician using a CAD system is believed to be made easier by displaying two different markers representing different probability thresholds. An additional threshold can be used to display “extra view markers” as an additional aid or guide to the radiologic technician to take extra views of a patient before the patient is released or discharged. A control device is added to allow the user to select and vary the probability threshold for the display of locational markers.

### REFERENCE TO RELATED APPLICATIONS

This application is a continuation-in-part of Ser. No. 09/946,209 filed Sep. 9, 2001 which in turn is a continuation-in-part of Ser. No. 09/891,676, filed Jun. 26, 2001 and of Ser. No. 09/798,756, filed Mar. 2, 2001. Ser. No. 09/891,676 in turn is a continuation of Ser. No. 09/179,205, filed Oct. 27, 1998 and now U.S. Pat. No. 6,266,435, which in turn is a continuation-in-part of Ser. Nos. 08/980,254, filed Nov. 28, 1997 (abandoned) and Ser. No. 08/579,802, filed Dec. 28, 1995 and now U.S. Pat. No. 5,828,774, which in turn is a continuation of Ser. No. 08/129,255, filed Sep. 29, 1993 (abandoned). Ser. No. 08/980,254 is in turn a continuation-in-part of application Ser. No. 08/579,802, filed on Dec. 28, 1995 (now U.S. Pat. No. 5,828,774) and of application Ser. No. 08/438,432, filed on May 10, 1995 (now U.S. Pat. No. 5,729,620), which in turn is a continuation-in-part of application Ser. No. 08/129,255, filed on Sep. 29, 1993 (abandoned). This application also claims priority from provisional application Ser. No. 60/252,775 filed on Nov. 22, 2000. This application hereby incorporates by reference the entire disclosure, drawings, and claims of each of the above-identified applications as though fully set forth herein.

### FIELD AND BACKGROUND OF THE INVENTION

The method and system described in this patent specification relate to displaying radiological images and other information in a manner to assist their reading and interpretation by physicians or other users of the method and system. More specifically, the patent specification relates to a computer-aided method and system for the detection and identification of anatomic abnormalities from radiological images.

Systems for computer-aided detection and diagnosis assist radiologists in the detection and classification of abnormal lesions in medical images. In the art, computer-aided detection and computer-aided diagnosis methods and systems are called CAD systems. In the present disclosure, the term CAD refers to both types of systems jointly and separately. The purpose of such CAD devices, as described in U.S. Pat. No. 5,815,591 to Roehrig, et. al., entitled “Method and Apparatus for Fast Detection of Spiculated Lesions in Digital Mammograms,” the disclosure of which is hereby incorporated by reference, is to direct the attention of a radiologist to suspicious areas of the medical image that may reflect a threatening condition. While not a replacement for the experienced radiologist, CAD systems are designed to increase efficiency and reduce error, as a typical radiologist may be required to examine hundreds of medical images per day, which can lead to the possibility of a missed diagnosis due to human error.

The detection of suspected abnormal anatomic regions in radiological images using a computer system comprising specialized software and sometimes specialized hardware has been reported. For example, in the area of mammography, two books published in the last few years are: (1) “Digital Mammography,” edited by A. G. Gale et al, published by Elsevier in 1994; and (2) “Digital Mammography '96,” edited by K. Doi et al, published by Elsevier in 1996.

Various systems and methods are currently known for computerized detection of abnormalities in radiographic images, such as those disclosed by Giger et al. in RadioGraphics, May 1993, pp. 647-656; Giger et al. in Proceedings of SPIE, Vol. 1445 (1991), pp. 101-103; U.S. Pat. No. 4,907,156 to Doi et al.; U.S. Pat. No. 5,133,020 to Giger et al.; U.S. Pat. No. 5,343,390 to Doi et al.; U.S. Pat. No. 5,491,627 to Zhang et al; and U.S. Pat. No. 5,537,485. These references are incorporated herein by reference as though fully set forth herein. Such CAD systems are believed to be particularly useful to radiologists and other medical specialists in diagnostic processes and specifically in radiologic screening procedures.

This subject matter has also been discussed in recently issued patents, for example: U.S. Pat. No. 4,907,156 (Doi et al); U.S. Pat. No. 5,133,020 (Giger et al), U.S. Pat. No. 5,212,637 (Saxena); U.S. Pat. No. 5,331,550 (Stafford et al); U.S. Pat. No. 5,365,429 (Carman); U.S. Pat. No. 5,452,367 (Bick et al); U.S. Pat. No. 5,491,627 (Zhang et al), U.S. Pat. No. 5,537,485 (Nishikawa et al); U.S. Pat. No. 5,572,565 (Abdel-Moottaleb); (U.S. Pat. No. 5,574,799 (Bankman et al); U.S. Pat. No. 5,579,360 (Abdel-Moottaleb); U.S. Pat. No. 5,586,160 (Mascio); U.S. Pat. No. 5,598,481 (Nishikawa et al); U.S. Pat. No. 5,615,243 (Gur et al); U.S. Pat. No. 5,627,907 (Gur et al); U.S. Pat. No. 5,633,948 (Kegelmeyer); U.S. Pat. No. 5,661,820 (Kegelmeyer); U.S. Pat. No. 5,657,362 (Giger et al); U.S. Pat. No. 5,666,434 (Nishikawa et al); U.S. Pat. No. 5,673,332 (Nishikawa et al); U.S. Pat. No. 5,729,620 (Wang); U.S. Pat. No. 5,732,697 (Zhang et al); U.S. Pat. No. 5,740,268 (Nishikawa et al); U.S. Pat. No. 5,815,591 (Roehrig et al); and U.S. Pat. No. 6,075,879 (Roehrig et al). Additionally, a commercial mammographic CAD system is being sold in this country under the trade name “ImageChecker” by R2 Technology, Inc. See also, the parent applications identified above, including the references cited therein as prior art or otherwise. The two books cited earlier, as well and the earlier-cited patent applications and patents, including the references cited therein, are hereby incorporated by reference in this patent specification as though fully set forth herein.

In a screening radiological procedure, a radiologist typically uses a light box to analyze X-ray films such as mammograms or chest images, in a very well-defined orientation and order. In such procedures, the patients are typically asymptomatic and cancers are said to be found at a typical rate of about one to ten cases per one thousand patient examinations. Reading the mammograms, when the vast majority of them are negative, can be a tedious task. It has been reported that it is difficult for physicians to maintain a constantly high attention level.

Some abnormalities that can be detected or diagnosed from the mammograms can be missed or misdiagnosed, which can result in delayed or more costly treatment, and can even result in a reduction of a patient's longevity or chance of survival. According to an article in the May 26, 1993 issue of JAMA, pages 2616-2617, the misdiagnosis rate in mammograms can be in the range of 15 to 63%. Several mammography clinical studies, as summarized in an article entitled “Estimating the accuracy of screening mammography: a meta-analysis,” published in Am. J. Prev. Med. (1998), volume 14, pages 143-152, indicate that the false negative (missed cancer) rate ranges from 5% to 17% for a first screening and increases to 14% to 44% for subsequent screenings. The CAD system, serving as an electronic reminder or second reader, can assist physicians in attaining higher detection rate (higher sensitivity) for cancers while reducing the misdiagnosis rate (lowering the false-negative rate). Thus, it is believed that the use of such CAD systems will continue to increase.

The following describes a typical procedure for detecting suspected abnormal anatomic features in mammograms using the commercial mammographic CAD system sold under the trade name ImageChecker. A set of four x-ray film mammograms, two views of each breast of a patient, taken by a radiological technician or a physician, are processed through a film digitizer to generate a set of four digitized images that are input as such into the ImageChecker system. Each of the four digitized images is then analyzed by a digital image processing computer with specialized software and typically some specialized hardware as well. The processing detects anatomic features that meet criteria for suspected abnormalities, and creates a respective annotated image for each of the film mammograms. The original film mammograms are then mounted on a conventional lightbox or alternatively, a motorized lightbox, for viewing. The annotated images of these mammograms are displayed on two small TV monitors located beneath the lightbox. Each small monitor displays two annotated images. Each annotated image comprises a sub-sampled digitized image of the corresponding film mammogram and locational markers marking the locations of the suspected abnormalities that the CAD processing detected. Currently, two different markers convey information regarding two key cancerous features of the suspected abnormalities that are detected. One marker is a triangle-shaped marker used to mark the location of a suspected abnormal cluster of microcalcifications. The other marker is a star-shaped marker used to mark the location of a suspected abnormal mass.

During a mammographic screening procedure, the CAD system typically over marks suspected abnormalities in order to ensure a high detection rate. Currently, the CAD systems in commercial use tend to report suspected abnormalities that have relative probability values of being abnormal that are above a certain selected threshold. The threshold is set low enough that the reporting rate is much higher, perhaps a hundred times higher, than the rate at which a physician would judge the abnormality sufficiently suspicious to warrant a recall of the patient for additional diagnostic work-up examinations. Therefore, a physician may have to examine and perhaps dismiss not only the suspected abnormalities that a physician would ordinarily detect from the film mammograms but also the typically greater number of suspected abnormalities detected by the CAD system.

During a mammographic examination, the radiological technician sometimes takes extra mammograms of a patient if the technician suspects or believes that an abnormality exists, or if a technical error is likely to have degraded a mammogram (such as patient motion, exposure error, positioning error, etc.). The added information from these extra mammograms is believed to have the potential of enabling the physician to reduce recall rates by assisting in assessing/dismissing abnormalities.

### SUMMARY OF THE INVENTION

Therefore, an object of this invention is to provide a high resolution digital image of a radiographic image such as a mammogram. In an embodiment of the invention, regions of interest such as calicifications, masses or other lesions (collectively called lesions) in a radiographic image are individually highlighted. Where a region of interest is detected, the pixels of the lesion are highlighted by superimposing a pixel of a different color, including white, in place of the pixels depicting the region.

In one embodiment of the invention, the digital image is constructed from an X-ray or a radiographic image; in other embodiments one or more digital images are obtained directly via digital system acquisition equipment. In another embodiment of the invention, a display device provides an option for toggling the highlighted color on or off. By toggling the colored pixels the radiologist is able to observe a region of interest with or without the colored pixels.

In another embodiment of the invention, a touch screen display is provided wherein a radiologist can view a medical image with highlighted regions of interest. Moreover, a radiologist can select to zoom in on regions of interest by touching the screen. The system then displays the medical image at full resolution, typically 50 microns. In another embodiment of the invention, a CRT display is provided wherein a radiologist can select to zoom in on regions of interest using an input device such as a mouse or keyboard.

### BRIEF DESCRIPTION OF THE DRAWINGS

For a better understanding of the invention, reference is be made to the following detailed description taken in conjunction with the accompanying drawings, in which:

FIG. 1 is a diagram of an embodiment of a computer aided detection system of the present invention;

FIG. 2 is a diagram of an embodiment of a computer aided detection system of the present invention;

FIG. 3 is diagram of a processing unit of the present invention;

FIG. 4 is a diagram of an embodiment of a computer aided detection system of the present invention;

FIG. 5 is a flowchart of a method of the present invention;

FIG. 6 is a block diagram of functional units of an embodiment of the present invention;

FIG. 7 is a diagram of digitized mammographic films as displayed in the present invention;

FIG. 8a is a digitized mammographic image as displayed in the present invention;

FIG. 8b is a magnified view of a digitized mammographic image as displayed in the present invention;

FIG. 9 is a flowchart of a method for displaying digitized mammographic images according to an embodiment of the invention;

FIG. 10 is a schematic diagram of a first exemplary embodiment of the invention;

FIG. 11A illustrates an annotation map having colored locational markers, wherein the probability values are displayed in analog form in a spectrum of colors, according to a second embodiment;

FIG. 11B illustrates an annotation map having differently sized locational markers, wherein the probability values are displayed in analog form according to the size of the locational markers, according to an alternate second embodiment; and

FIG. 12 is a curve illustrating the selection and placement of two different probability thresholds for two markers.

### DETAILED DESCRIPTION OF THE INVENTION

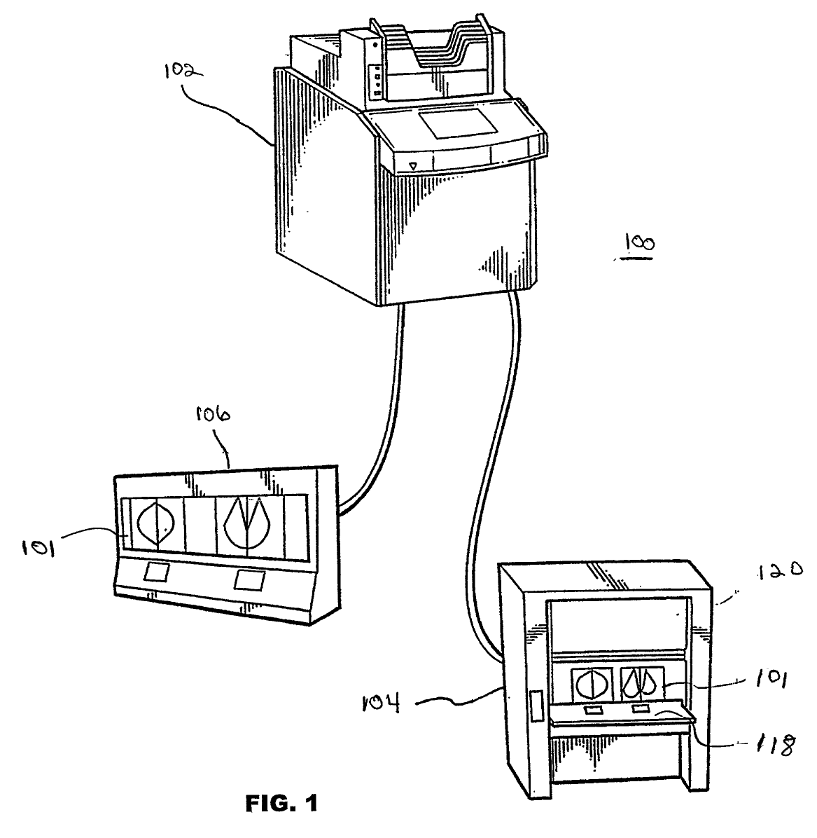

A system for the detection of breast carcinoma is illustrated in FIG. 1. As shown, detection system 100 comprises a processing unit 102, a motorized viewer 104, and a wet read viewer 106. According to this embodiment, mammography x-ray films are loaded, scanned and analyzed by a processing unit 102. After the x-ray films are analyzed by processing unit 102, data representing regions of interest identified by the processing unit are transmitted for display to one or more viewers. In the example shown in FIG. 1, the data is be sent to motorized viewer 104, wet read viewer 106, or both.

Note that although these preferred embodiments are described with respect to detection systems that process and analyze mammography x-ray films, the present invention is readily adaptable to many other types of CAD systems. One of skill in the art understands that each unit can be modified to perform identical functions. For example, the present invention is applicable to CAD systems which analyze other kinds of images besides x-ray films. The invention is applicable to CAD systems which process any type of film-based or digital medical images. For example, ultrasound imaging, nuclear magnetic resonance imaging, computer tomography imaging, and scintillation camera imaging all produce images which may be film-based. Additionally, film-based medical images are carried on a wide variety of film-like materials such as vellum, or any other transparent or translucent media.

While detection system 100 is shown illustrated for film-based images, alternate embodiments based on non-film systems are also possible and are noted further herein. For example, digital images may be obtained and processed from a digital imaging system.

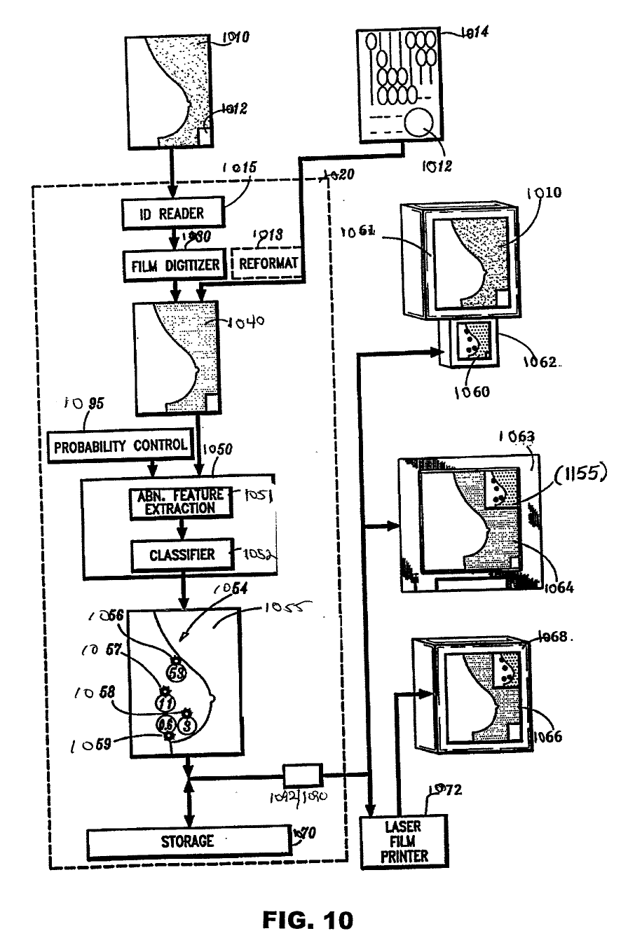

Digital images can then be stored or processed, in a manner as similarly described further herein for digitized image 1040 in FIG. 10, since the images are already in a digital format or other format appropriate for digital image processing without the intermediate need or use of x-ray or other analog images.

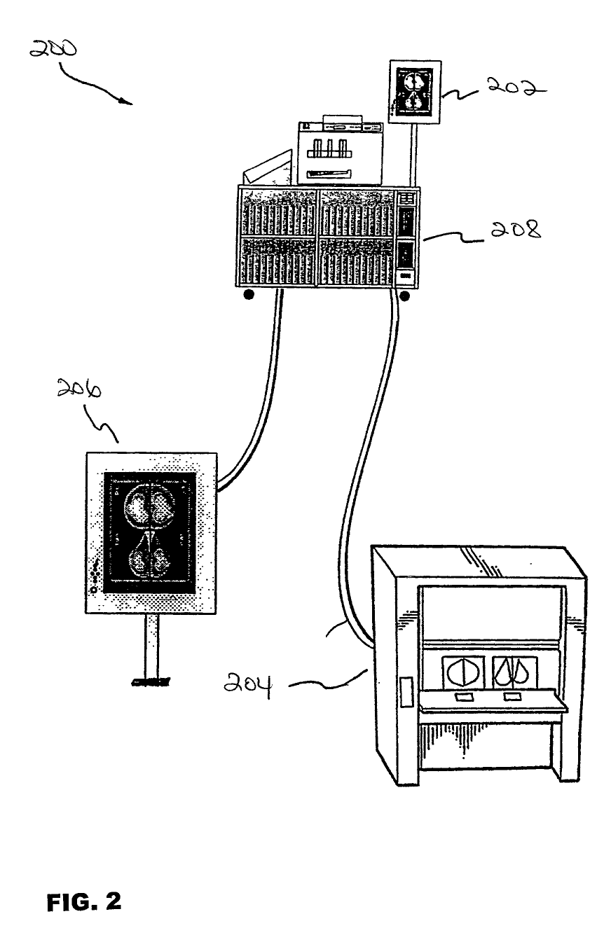

Referring now to FIG. 2, the components in a processing system 200 to process film-based images, such as those processed by processor 102 or 208, or to process digital or digitized images and wet read viewer 106 for film-based images, will now be described in greater detail according to a preferred embodiment of the invention. As shown, processing system 200 houses a user interface 202, scanning unit 204 (primarily for film-based images), and processing unit 206. Note that although the scanning unit, for film-based images, and processing unit are housed within processing unit 206, they can also be provided separately or in other combinations. In general, processing unit 206 comprises a computer-based system for analyzing and processing digital images for the detection of anatomical abnormalities. However, processing unit 208 is generally the processor of almost any CAD system. For example, the present invention is applicable to and could be adapted to facilitate the input of film-based and digital images into any of the CAD systems mentioned and incorporated by reference above.

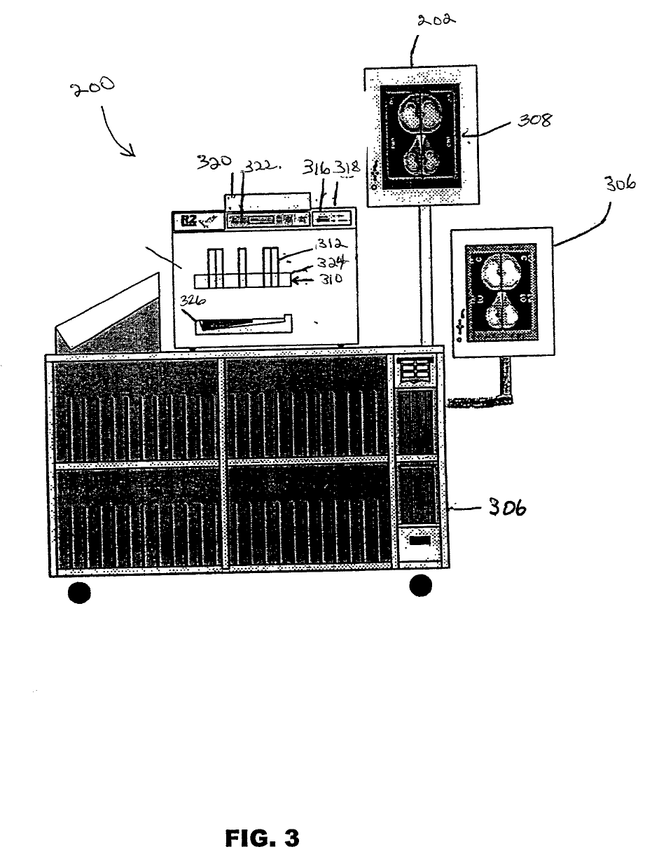

As shown in FIG. 3, user interface 202 contains a display panel 308 which is a touch sensitive flat panel display and may include a viewer 306, which may be a wet read viewer but can be another touch sensitive flat panel display where both display panel 308 and viewer 306 are placed in close proximity so that a user is able to access both with ease. An alternative embodiment of the invention implements a touch sensitive flat panel display to function as both the display panel 308 and the wet read viewer 306.

As shown in FIG. 3, user interface system 300 comprises a film feeding mechanism 310 for film-based systems which handles and feeds the films in serial fashion to scanning unit 304. Film feeding mechanism 310 comprises a stack film feeder 312 that is capable of holding a large number of films. According to a preferred embodiment of the invention, film feeding mechanism 310 is designed so as to accommodate cases of films where each case of films is made up of a number of films obtained from a single patient. For example, in the United States, it is common for a case to be composed of four mammography x-ray films. Each breast is usually imaged twice: the first image being a top view ordinarily called the Cranial Caudal view (“CC”), and the second image being a lateral view ordinarily called the Medio-Lateral Oblique view (“MLO”). The invention can accommodate cases composed of a number of films up to the maximum capacity of the stack film feeder 312.

According to a preferred embodiment, film feeding mechanism 310 comprises a stack film feeder 312 capable of feeding relatively large numbers of films. Stack film feeder 312 individually feeds films to scanning unit 304 as required during processing on either a first-in-first-out (“FIFO”) basis or last-in-first-out (“LIFO”) basis. Suitable stack film feeders 612 are currently or will soon be commercially available from vendors such as Konica, Canon and Abe Sekkei. Sometimes such feeders are called bulk loaders or stack loaders. Note that in embodiments where each film has its own bar code label, a bar code reader is provided in stack film feeder 312. Preferably, graphical or electromechanical user interface implemented motorized viewer 204 or wet read viewer 206 controls the organization of images processed en masse.

Additionally, film feeding mechanism 310 is designed so as to accommodate the size of films ordinarily used in a particular application. For example, in a preferred embodiment, stack film feeder 312 is designed to hold either 18 cm×24 cm, or 24 cm×30 cm films. This is accomplished by providing a film feeding mechanism with a throat that is 24 cm wide to accommodate both film sizes, in which case the 18 cm×24 cm films are rotated in software using standard digital image rotation techniques. Furthermore, a preferred embodiment of the invention utilizes a cover sheet with a tab 1010 (see FIG. 10) that protrudes beyond the other films. Thus it is necessary that the film feeding mechanism be designed so as to accommodate the protruding tab.

Transport mechanism 324 transports the films individually from film feeder 312 to scanning unit 304. After the scanning unit 304 has completed scanning a film, the film is ejected to an output film holder 326, and transport mechanism 324 feeds the next film to scanning unit 304. According to a preferred embodiment, film feeding mechanism 310 and transport mechanism 324 comprises a commonly available film feeding unit such as those commercially available from Konica, Canon and Abe Sekkei.

Scanning unit 304 generates from each x-ray film a two-dimensional mammographic image. Preferably, scanning unit 304 is a laser film digitizer and has a dynamic range and spatial resolution comparable to those of the original mammographic film which typically has a dynamic range of 10,000:1 and spatial resolution of approximately 50 microns per pixel.

Although film feeding mechanism 310 and scanning unit 304 are described herein according to certain preferred embodiments, in general many alternative types of feeding mechanisms and scanners can be used, depending on the particular application. For example, suitable scanners are commercially available from a number of vendors including Konica, Canon and Abe Sekkei.

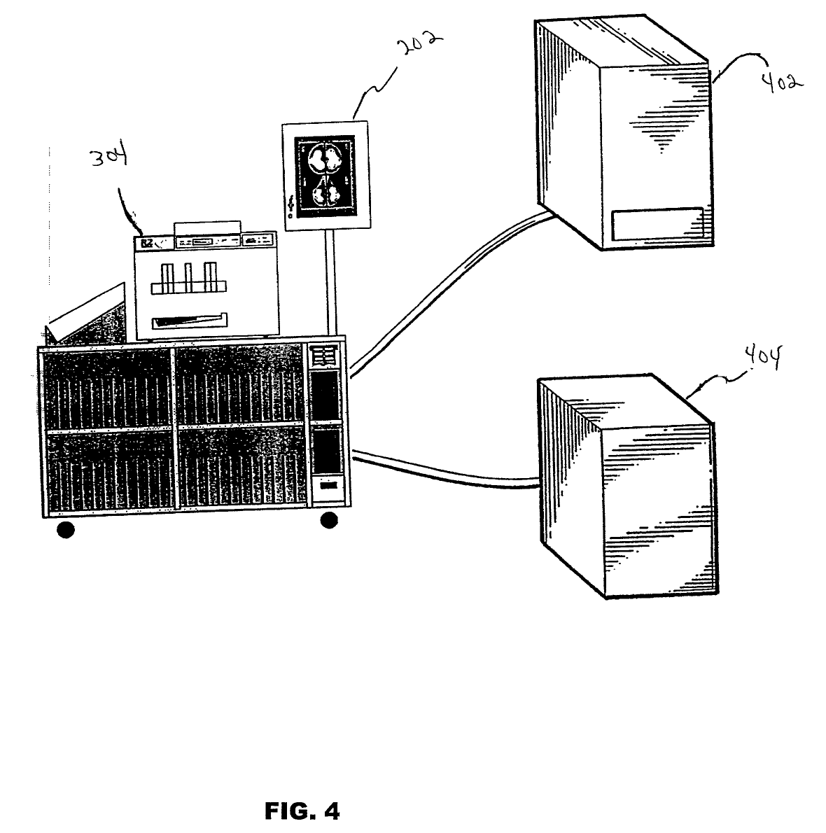

Additionally, in some embodiments certain medical images are already in digital format, such as images that were acquired with a digital medical imaging system, or that are stored in a digital image storage system. According to the invention, an example of a computer-aided detection system which receives images already in digital format is shown in FIG. 4. Although processing unit 304 is shown connected to both digital image storage system 404 and digital medical imaging system 404, in general only one source of digital image data is needed. A wide variety of digital medical imaging systems currently exist. Some examples are: computer tomography systems, digital ultrasound imaging systems, scintillation camera systems, digital stimulated emission phosphor plate radiography systems, nuclear magnetic imaging systems, and digital mammographic systems. An example of a digital image storage system is disclosed in U.S. Pat. No. 5,416,602 to Inga et al., entitled “Medical Image System With Progressive Resolution” incorporated herein by reference. In the case where medical images are already in digital format, the feeding and scanning functions of the system are not needed. In such cases, the operator monitors the digital data being received by the system using the display panel, and is able to re-orient or change the order of images electronically, as will be described in greater detail below.

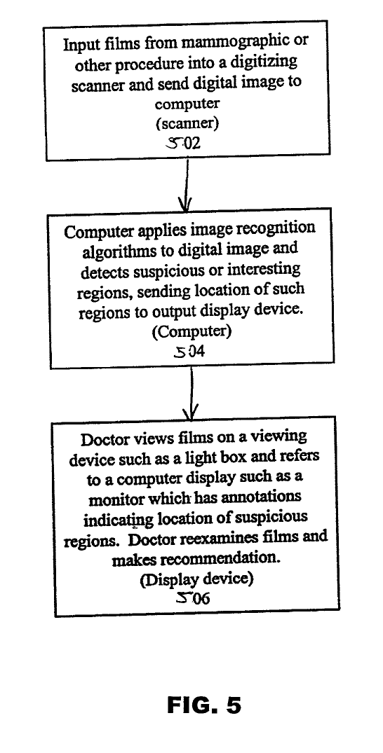

FIG. 5 shows the general steps performed by CAD processing unit 1020 (FIG. 10) on the x-ray mammogram. Reference will be made to processing unit 102, however, one of skill in the art understands that the discussion is applicable to processing unit 300 as well as to other digital processing units. At step 502, multiple related x-ray mammograms are scanned in and digitized into digital mammograms. To create the x-rays mammograms, the breast is positioned and compressed between two plates before the X-ray is actually taken. Two views, corresponding to two approximately orthogonal orientations of the compression planes are taken, typically called Cranial Caudal (CC) view and Medio-Lateral Oblique (MLO) view. The resulting four films are developed, and digitized by the CAD system 100. The digitized image is then sent to a computer for processing at step 804. Alternatively, the x-ray mammograms are digitized directly using a digital x-ray machine. Preferably, such machines have resolution better than or as good as digital images obtained via scanning. In any event, the resulting digitized images can then be displayed or stored for further processing.

The digital mammograms are processed at step 504 by an overall suspicious lesion detection algorithm in accordance with the preferred embodiments. The overall lesion detection algorithm performed at step 804 generates a list of locations in at least one of the digital mammogram images which correspond to suspicious lesions, i.e. possibly cancerous lesions. The algorithm operates independently on each image, without regard for what lesions are found or not found in the other images. Following step 504, the digital mammogram images and list of suspicious locations is sent for display to the viewing station 104 at step 506.

At step 506, the system of the present invention displays a digitized image of the breast mammogram with indicators overlaid on the image indicating regions of interest. At step 506, the doctor also has available the original conventionally developed mammographic films to which he can refer. After thoroughly examining the films and the digitized images, the doctor makes a recommendation.

As an alternative to the manual x-ray development following by the digitization performed at step 502, the x-ray detector, which at present is usually a film screen cassette, can be replaced by a direct digital detector such as the General Electric Full Field Digital Mammography System, and the resulting digital image fed directly to the CAD processing unit 402.

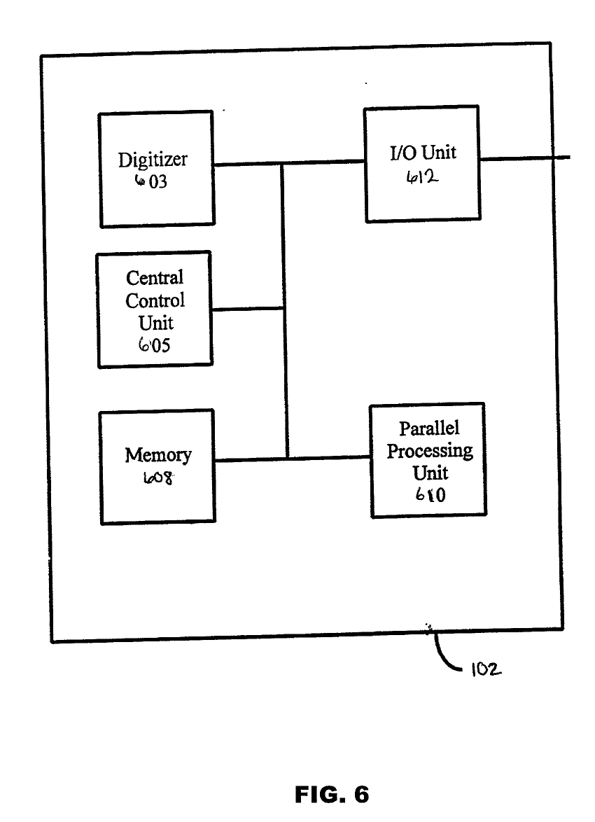

Referring to FIG. 6, the components of a processor 102 are shown. The processor includes an input/output unit interface 612. For film-based images, a digitizer 603 creates digitized images for processing by a processing unit 610. For digital mammography systems where digital images are received via interface 612, processing by the digitizer may not be necessary, and in some embodiments a digitizer 603 would not be required or used. A central control unit 605 manages the flow, exchange and control of data within processor 102. Memory 608 can be used to store digitized images from digitizer 603 and results obtained by the processing unit 610.

In one preferred embodiment, the highlighted digital mammogram will have a marker such as an asterisk (*) superimposed on those locations corresponding to suspicious lesions, and a triangle (Δ) superimposed on calcification clusters. Further information regarding CAD system 400 may be found in U.S. Pat. No. 5,815,591, supra.

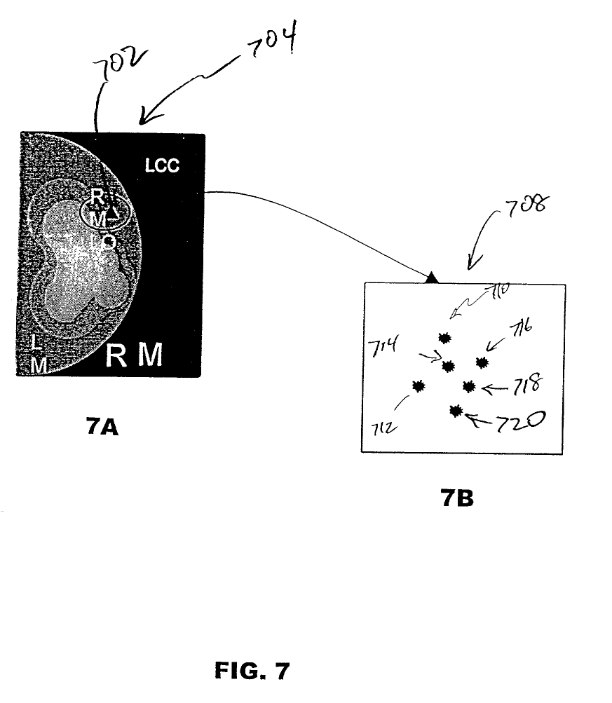

In an embodiment of the invention shown in FIG. 7a, a marker 702, in this case a triangle, is shown at the centroid of several calcifications on a digitized radiographic image that is in this case a mammographic image 704. The marker 702 is useful because it provides a prompt or stimulus to the radiologist to closely examine the original image at the position of the marker. Upon further examination, a radiologist can revise his opinion based on his closer observation of the original image. As an enhancement, further information is provided by showing the radiologist exactly which pixels the code considered suspicious. As shown in FIG. 7b, pixels groups 710-720 correspond to a close up view of the region surrounding marker 702. Pixel groups 710-720 may be highlighted with a particular color such as white or red. In an embodiment of the invention, a display device, such as wet read view 306 or user interface 300 (see FIGS. 2-5, infra), is used to display mammographic images 704 and 706 where the display device is a touch screen. In such an embodiment, the radiologist can select to view an area surrounding a marker 702 by simply touching the marker on the screen. The system then provides a close up view of the region with the highlighted pixels. In yet another embodiment of the invention, the display device is a cathode ray tube (CRT) connected to an input device such as a keyboard or mouse whereby the input device is used to command the system to provide a close up view and to highlight the suspicious pixels.

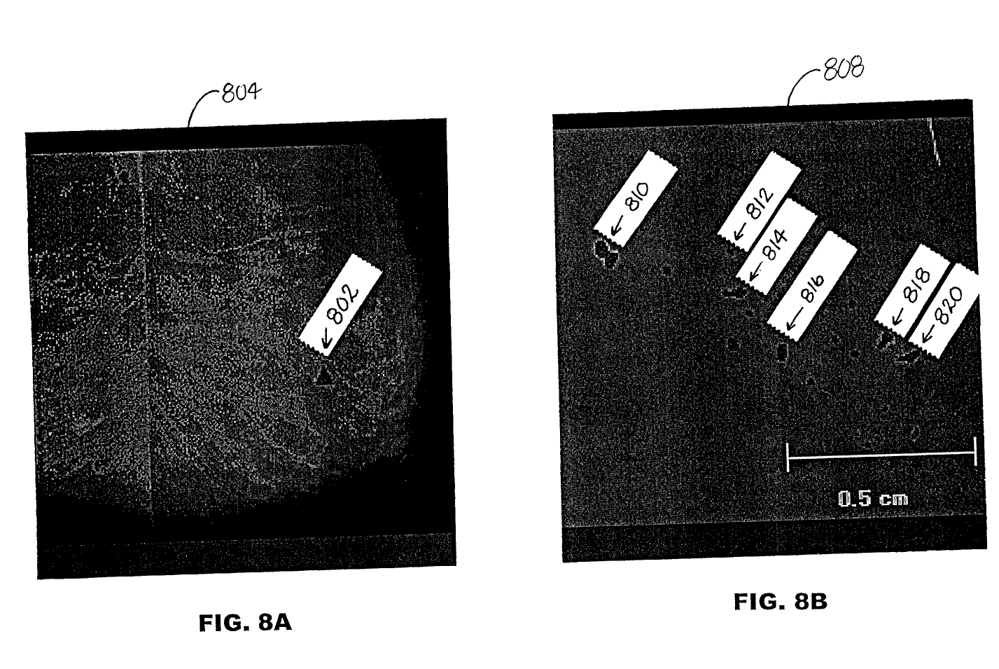

FIG. 8 shows actual images from a CAD system. As shown in FIG. 8a, a triangular marker 802 is shown on a digitized mammographic image 804 indicating the centroid of a calcification cluster. A cluster is typically defined as two (2) or more calcifications located within a physical distance of each other, typically one (1) square centimeter. A single marker can represent an entire cluster, which may be any size. Using a close up view in FIG. 8b, pixel groups 810-820 are highlighted. The highlighted pixels are identified by a lesion, calcification, mass or spiculation algorithm as corresponding to an region of interest meeting predetermined criteria.

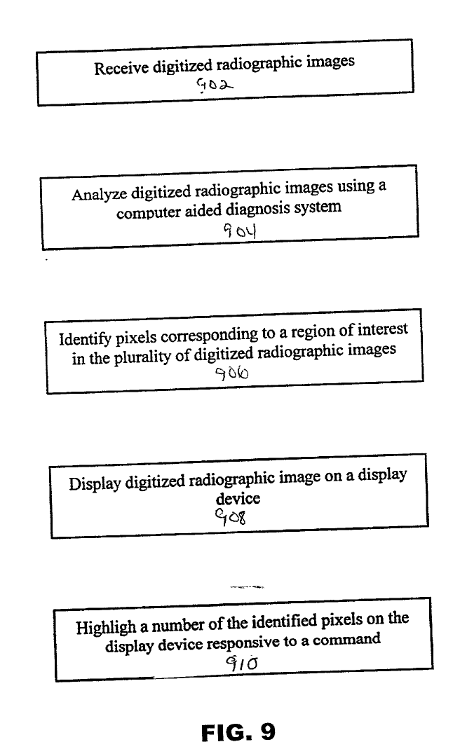

FIG. 9 shows a method of the present invention for displaying markers and highlighting pixels corresponding to suspicious regions of interest such as calcifications. At step 902, a computer-aided diagnosis system of the present invention receives digitized radiographic images such as mammograms. The digitized images can be produced by scanning a radiographic film or by directly creating a digitized image using digitizing detector arrays. At step 904, the digitized radiographic images are analyzed using a computer aided diagnosis system. This analysis can be tailored to detect various regions of interest as known in the art. In particular, the analysis can detect calcifications, masses, spiculations or other anatomically suspicious regions. At step 906, the computer-aided diagnosis system identifies the exact pixels corresponding to a region of interest in the plurality of digitized radiographic images which are comprised of an array of pixels. At step 908, a digitized radiographic image is displayed on a display device such as a cathode ray tube or a flat panel display. In an embodiment of the invention, a marker is also displayed at the centroid of the region of interest such as at the center of a cluster of calcifications. Responsive to a command such as by touching a touch screen or by using another type of input device such as a keyboard or mouse, a number of the identified pixels are highlighted on the display device at step 910. The highlighting can be accomplished by applying a distinctive color such as white or red to the identified pixels. Moreover, in an embodiment, a close-up view is provided responsive to a command such that the radiographic image is shown at high resolution and the highlighting is also shown at high resolution. In another embodiment of the invention, the highlight on the identified pixels can be toggled on or off responsive to a command so that a radiologist can closely examine an identified region of interest such as a calcification. A radiologist can then use the displayed radiographic images including the close-up view with the highlighting on and off to supplement his evaluation of the digitized radiographic images as well as the actual radiographic films.

In another embodiment, hard copy or printed images are produced responsive to a command. Responsive to a command such as by touching a touch screen or by using another type of input device such as a keyboard or mouse, a high resolution image is printed using a printer. The printed image includes highlighting by applying a distinctive color such as white or red to the identified pixels. Moreover, in an embodiment, a close-up view is printed responsive to a command such that the printed radiographic image is shown at high resolution and the highlighting is also shown at high resolution. A radiologist can then use the printed radiographic image to supplement his evaluation of the digitized or digital radiographic images as well as the actual radiographic films.

Referring to FIG. 10, a preferred but non-limiting example of the method and system described herein involves providing annotation information that can include assessments of the probability, likelihood or predictive values of CAD-detected suspected abnormalities, in addition to the locational information, as an aid to the radiologist or other user of the method and system. In this example, the radiologic image is in the form of a mammographic x-ray film, which is acquired with a conventional mammographic film-screen imaging system. The original analog two-dimensional mammographic x-ray film 10 is sent through the digitizer 1030 of CAD system 1020 (such as that disclosed in said U.S. patents and applications incorporated by reference herein) to obtain digitized two-dimensional mammographic image 1040. Preferably, film digitizer 1030 is a high resolution CCD or laser film digitizer and has a dynamic range and a spatial resolution comparable to those of the original mammographic film that typically has a dynamic range of 3,000:1 to over 10,000:1 and spatial resolution of approximately 50 to 100 microns per pixel (or about 4,000×5000 to 2,000×2500 pixels for an 8 inch×10 inch film mammogram). The identity of original mammographic image 1010 also is preferably entered into CAD system 1020 at this point to identify digitized mammographic image 1040. A useful option at this point is to automatically input the identity of original mammographic image 1010 into CAD system 1020. This can be accomplished, for example, by first labeling mammographic film 1010 with a code such as a bar code, and then by reading the label into CAD system 1020 with optional ID bar code reader 1015 as the mammographic film 1010 is, in one embodiment, fed into film digitizer 1030.

Referring to FIG. 10, the method and system 1000, can also receive radiological images 1014 that are already in a digital format, and detect suspected abnormalities on these radiological images with CAD system 1020. Preferably, these radiological images, together with CAD results, can be printed on photographic film or otherwise stored directly without any intermediate steps requiring, particularly in the case of film, the manual feed of x-ray or analog images into an ID reader 1015 or without requiring use of a film digitizer 1020. Digital imaging systems, such as magnetic resonance imaging (“MRI”) systems, computed tomography (“CT”) systems, ultrasound imaging systems, scintillation cameras, computed radiography (“CR”) systems (such as Fuji's CR system based on stimulated emission phosphor detector), flat panel type (using amorphous silicon array detectors) digital radiography and digital mammography systems provide radiological images in the digital format. In this nonlimiting example, the radiological image is in the form of digital mammogram 1014, which is acquired with a digital mammography system. Preferred digital acquisition systems can create digital images directly without the need of film and without the need of intermediate steps of converting film-based analog images to digital images. Additionally, digital image data is preferably processed with correction for known error sources and disturbances to provide a more accurate digital profile. Digital mammogram 1014, preferably already having a properly encoded identification and patient information 1012, can be reformatted at reformatter 1013 into digitized mammographic image 1040 and sent through abnormal feature detection stage 1050 of CAD machine 1020. If digital image 1014 is already properly formatted for CAD machine 1020, it is sent directly to and through abnormal feature detection stage 1050 of CAD machine 1020 without reformatting, as the initial film digitization step used in analog x-ray film example is not needed in this case.

Digitized mammographic image 1040 is sent through abnormal feature detection stage 1050 of CAD system 1020. Key components of abnormal feature detection stage 1050, abnormal feature extraction sub-stage 1051 and classifier sub-stage 1052 have been described in detail in said U.S. patents and applications incorporated by reference herein. The output of abnormal feature extraction sub-stage 1051 is usually the features and locational information of the detected suspected abnormalities. The output of classifier sub-stage 1052 is usually the probability information of the detected abnormalities. Although several types of neural network classifiers (particularly feed-forward, multi layer, neural network classifiers) have been used in radiological CAD systems, other usable classifiers have been described, for example, in a book by K. Fukunaga (entitled: “Introduction to statistical pattern recognition,” published by Academic Press in 1990) and a book by R. Duda and P. Hart (entitled: “Pattern Classification and scene analysis,” published by John Wiley & Sons in 1973).

The findings or results from abnormal feature detection stage 1050 are in the form of two-dimensional annotation map or x-y coordinate information 1055 of the locations of the CAD-detected suspected abnormalities that have probability values of being abnormal that are above a certain selected threshold. In some configurations, the results also can be provided in 3-D views, created from a set of 2-D images. In other configurations, the results are shown in multiple display windows wherein at least one window display is a 2-D rendering, and at least one display window is a 3-D rendering of the results.

In the illustrative example depicted in FIG. 10, four CAD-detected suspected abnormalities have been found through the analysis of digitized version 1040 of original film 1010, and are illustrated at regions of interest (ROIs) 1056, 1057, 1058 and 1059 on annotation map 1055. For the purpose of illustration, let the ROIs 1056, 1057, 1058 and 1059 have probability values of being abnormal at 53, 11, 3 and 0.6%, respectively. Illustratively, the threshold at which these probability values are displayed is less than 0.6%. Therefore all four ROIs 1056, 1057, 1058 and 1059 are displayed. If the probability threshold were set at 5%, only ROIs 1056 and 1057 would be displayed. Thus, the markers identify not only the detected location but also display the probabilities of being abnormal that are above a certain preselected threshold. In some embodiments, information (such as probability information associated with the markers) can be placed in a margin or edge away from a breast image. The annotation map 1055 can be scaled down to the size of a sub-sampled digital image of the respective film mammogram, say 512×512 pixel in size and 8-bit in a gray scale image of the digitized image 1040. The scaled-down gray scale image and the annotation map 1055 can be superimposed on each other in registration to form miniaturized superimposed map image 1060 that can be displayed and used as discussed below. The annotation map 1055 can be shown with the breast outline 1054 or the breast outline can be removed from the superimposed image 1060. One or more of CAD-generated annotation map 1055, reduced size gray scale image, superimposed image 1060, and digitized image 1040 and its corresponding identification, can be stored in an optional memory storage unit 1070 in digital form.

For viewing, annotation map 1055 is transferred to an output display section of the system. Different displays are available depending on whether the digitized image 1040 was obtained from an x-ray or was directly generated. The output display section of the CAD system can be a part of the total CAD system, in which case the data transfer can be conducted, for example, through a dedicated shielded cable. Or, the output display section can be a separate system, in which case an additional data storage memory may be added to the unit to store the transferred interim data and the data transfer may be conducted through a dedicated shielded cable or an existing network to where the viewing equipment is installed.

It is important to point out and emphasize the abnormal features of the CAD detected abnormalities to the physician because it is believed that the physician, even after seeing the location of the CAD detected abnormalities on annotation map 1055, can fail to notice or appreciate these abnormal features on the original x-ray film mammogram. By pointing these abnormal features out to the physician with further emphasis on their relative probability value, it is believed that the physician would be in better position to assess the meaning and significance of these CAD detected suspected abnormalities.

A CAD output display is illustrated in FIG. 10 comprising a conventional film illuminator 1061, commonly called a lightbox, and a small TV monitor 1062. Monitor 1062 displays the superimposed image 1060 resulting from superimposing in registration annotation map 1055 and reduced scale digital image 1041. By operating toggle switch 1090 the user can turn on-and-off image 1060 at TV monitor 1062. The dimensions of the display screen of the small TV monitor 1062 in this example are of the order of ¼ to ½ of the dimensions of original x-ray film mammogram 1010. Because a physician usually views a set of four mammograms from each patient at a time, one or more small TV monitors 1062 can be used to display one or more annotation maps 1055 of the corresponding film mammograms. During a physician's reading session, each small TV monitor 1062 preferably is located or moved to (if mounted on a movable device such as an arm) as close as practical to the original film(s) 1010 displayed at light box 1061. Preferably the center of each small TV monitor 1062 should be less than 12 inches from the center of the respective original film(s) 1010 on conventional film illumination light box 1061 to minimize eye movement.

There are several methods to display the CAD results and the digitally acquired mammogram. Because a digital system typically produces no film at the data acquisition stage, a first method is a totally filmless display using a high resolution TV monitor 1063.

The resolution should preferably be at least 1000 X 1000 pixels. In this method annotation map 1055 (or a combined image corresponding to image 1060) and digital mammogram 1040 are all displayed on the same TV monitor 1063 as a combined digital image 1064 as shown in FIG. 10. Annotation map 1055, with the relative probability values displayed adjacent to ROIs 1056, 1057, 1058 and 1059, can be displayed in one of many locations or arrangements of a display as part of a combined image where, for example, annotation map 1055 is on top of and in registration with digital mammogram 1040 or displayed at a margin or edge of digital mammogram 1040 (as illustrated). By operating toggle switch 1090 the user can turn on-and-off or otherwise select a position or orientation for annotation map 1055 in the combined image 1064. Alternatively, the toggle switch can allow for the switching the displayed image, such as toggling between displaying only annotation map 1055 on monitor 1063 or displaying combined digital image 1064.

A second display mode of the digitally acquired mammogram is to print out digitized mammogram 1040 on photographic film 1066 and view it at a lightbox 1068.

Annotation map 1055 (or a superimposed image corresponding to image 1060), with the relative probability values displayed adjacent to ROIs 1056, 1057, 1058 and 1059, can be placed on the same edge or margin of the printout film as patient information label 1012. The photographic film printout, typically having a resolution of 4000×5000 pixels, can be made with high resolution laser film printer 1072. Such high resolution, 4000×5000 pixels, laser film printers are commercially available with a resolution of 50 microns per pixel for 8 inch×10 inch size films and 100 microns per pixel for 14 inch×17 inch size films. It is sometimes preferred that only miniaturized annotation map 1060 of annotation map 1055 be printed on the edge of the printout film 1066.

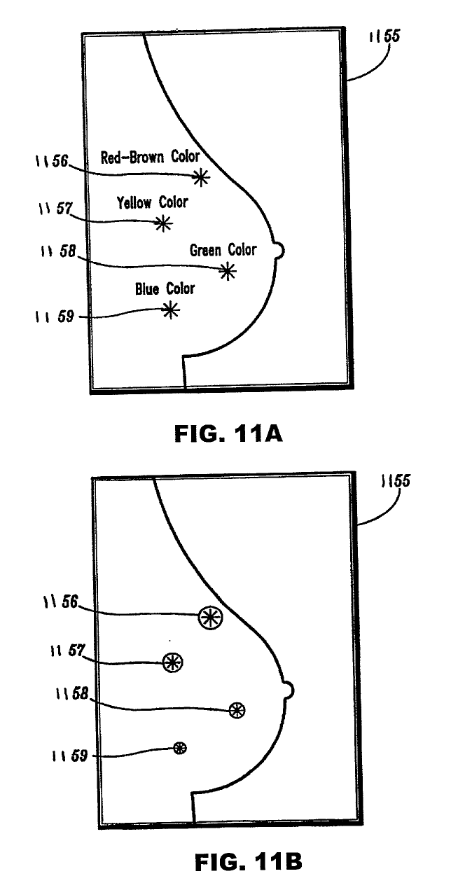

FIG. 11A, according to a second embodiment, illustrates annotation map 1155, similar to map 1055 but having colored ROIs 1156, 1157, 1158 and 1159. For example, “false” colors are assigned to represent the relative probability values in much the same way as “false” colors are assigned to represent elevation in a topographical map.

FIG. 11B illustrates annotation map 1155 having differently sized ROIs 1156, 1157, 1158 and 1159, whereas the relative probability value is displayed in analog form, represented by the size of the locational markers.

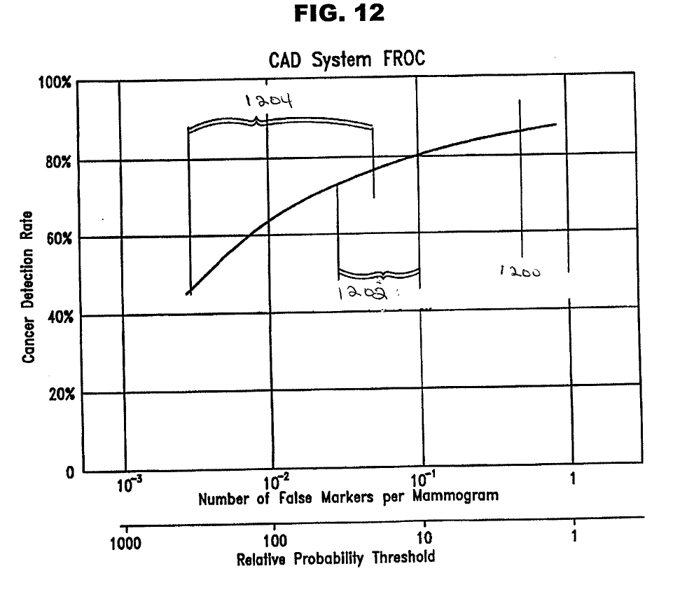

FIG. 12 is a free response receiver operating characteristics (FROC) curve of a CAD system where the system's cancer detection percentage is plotted against the locational marker's relative probability threshold setting. The CAD system's detection percentage varies inversely with the logarithm of the probability threshold setting. As the probability threshold is lowered, the detection percentage increases. The false marker rate on non-cancer mammograms is inversely proportional to the probability threshold setting. That is, as the probability threshold is lowered, the false marker rate increases.

A user of the method and system described herein can select the probability thresholds with the guide of the FROC curve. For example, a first probability threshold setting point 1200 is selected to display many subtle abnormalities with a high cancer detection rate of approximately 85% in this example and a rather high false marker rate of 0.5 per normal mammogram. This false marker rate is equivalent to approximately 500 false marks per cancer detected. A typical physician's recall rate for diagnostic examination can be 5 to 20 per cancer detected. Thus, this false marker rate is substantially higher than the rate of abnormalities that a physician would typically expect.

Not knowing the probability or significance of each marker and not wishing to overlook significant cancers, a physician may elect to regard all markers as equally significant and thus spend an equal amount of time to dismiss each marker. Thus, the physician may spend too much time on the task of dismissing low probability markers. On the other hand, not wishing to miss subtle cancers, the CAD system designer may not want to offer a system with too high a probability threshold setting. A solution to this problem is provided in the above described exemplary embodiments. Knowing the probability of the markers, the physician could then efficiently allot his or her time in assessing/dismissing the markers. With color, size or numerical probability indicators, some physicians may feel the display is too busy or too complex for efficient readings of the mammograms. A solution in such a case is to select a second threshold, for example at threshold 1202, set in the range of approximately 1 to 5 times a typical physician's recall rate for diagnostic examination, to thereby separate out probability markers that appear only occasionally so that the physician can better allot his or her time in assessing/dismissing the markers. Depending on the physician's recall rate, threshold 1202 should be set at a rate of, e.g., once every 4 to 250 mammograms. In the more developed countries, where the breast cancer rates tend to be higher than in less developed countries, threshold 1202 at a setting of one marker every 10 to 40 mammograms may be a reasonable compromise. A separate marker, differing from the first threshold markers in color, shape or size, can be used for the second threshold. Of course, some physicians may prefer more than two thresholds, in which case the system can accommodate that choice as well.

FIG. 12 also illustrates the selection and placement of an “extra view markers” threshold 1204. This threshold can be set at or near the physician's typical recall rate for diagnostic examination. That is, depending on the physician's recall rate, an “extra view marker” is displayed to the technician to suggest extra views at a rate of once every 20 to 250 mammograms.

Referring to FIG. 10, according to yet another embodiment, a control device 1095 is provided to allow the user to select and vary the probability threshold for the display of locational markers. By varying the probability threshold, the user can selectively set the probability threshold to taste or selectively view the markers with very low probability to markers with very high probability.

Experience has shown that there are situations where the further information provided by highlighted pixels is useful in reducing false positive indications sometimes called “false markers.” Computer-aided detection codes use objective data which sometimes leads to these false markers and a possible waste of time for the radiologist. Using the present invention, however, the radiologist's time is much better optimized. By showing the radiologist exactly which pixels the computer algorithm considered suscipious, the radiologist can more easily and effectively evaluate and dismiss false markers.

Furthermore, the present invention allows the radiologist to more readily evaluate true markers corresponding to malignant clusters.

Further experience has shown that a radiologist is more likely to take action on a cluster the more conspicuous it is. A cluster is more conspicuous if, for example, many individual calcifications comprise a cluster or the edges of the calcifications are extremely jagged or “angry”. Jagged or “angry” edges correspond to spiculations. In evaluating mammographic images, spiculated calcifications are the most likely to be malignant and require the most careful attention. In certain situations, however, a malignant cluster of calcifications is very subtle with small calcification such that a true estimate of malignancy is difficult. By highlighting or coloring pixels that an algorithm detects as suspicious, the cluster is easier to appreciate as malignant.

It is to be appreciated that in addition to being able to display a single view of one breast, CAD system 1020 may be used in accordance with the preferred embodiments to simultaneously display information related to multiple views of the same breast, similar Gil views of both breasts, and/or views of a single breast taken at different points in time. Thus, the attention of the radiologist may be drawn to specific areas of a first mammogram image by CAD system 1020, which can then be compared to corresponding areas of other views of the same breast, views of the other breast, or previous views of the same breast for making an appropriate determination.

Those skilled in the art understand that other anatomical features are common in mammographic images. More generally, those of skill in the art understand that other types of radiographic images such as chest x-rays contain common anatomical features or characteristics which can be used to provide orientation and identity information. In an embodiment of the invention, the chest wall as imaged on a mammographic film is identified to provide orientation information.

While preferred embodiments of the invention have been described, the descriptions are merely illustrative and are not intended to limit the present invention. For example, although the embodiments of the invention described above were in the context of a system for computer-aided diagnosis and detection of breast carcinoma in x-ray films, those skilled in the art will recognize that the disclosed methods and structures are readily adaptable to broader application. For example, the invention is applicable to many other types of CAD systems for detecting other types of anatomical abnormalities, including but not limited to chest x-ray, magnetic resonance imaging, and nuclear medicine.

What is claimed is:

1. A method for displaying at least one digitized radiographic image, comprising the steps of:
receiving a radiographic image;
digitizing the radiographic image to create a digitized radiographic image;
analyzing the digitized radiographic image using a computer aided diagnosis system;
identifying pixels corresponding to a region of interest in the digitized radiographic image;
displaying the at least one digitized radiographic image on a display device; and
highlighting the identified pixels on the display device responsive to a command.

2. The method of claim 1 wherein the radiographic image is an x-ray mammogram.

3. The method of claim 1 further including the step of providing annotation information related to a region of interest.

4. The method of claim 2 further including the step of identifying the radiographic image corresponding to the digitized radiographic image displayed on the display device.

5. A method for displaying at least one digital image, comprising the steps of:
receiving a digital radiographic image;
analyzing the digital image using a computer-aided diagnosis system;
identifying pixels corresponding to a region of interest in the digital image;
displaying the at least one digital image on a display device; and
highlighting the identified pixels on the display device responsive to a command.

6. The method of claim 5 further including the step of providing annotation information related to a region of interest.

7. The method for displaying digital images of claim 5 wherein the step of receiving digital images includes receiving an image and digitizing the image to create the digital image.

8. A computer-aided diagnosis system comprising:
a source of digital image data having a selected spatial resolution;
a processor coupled to said source for receiving and processing said data to detect abnormal anatomical features meeting selected criteria and for identifying pixels corresponding to said abnormal anatomical features; and
a display coupled with said processor for displaying digital image data corresponding, the display device displaying the pixels corresponding to said abnormal anatomical features.

9. The computer-aided diagnosis system of claim 8 wherein the digital image data is obtained from x-ray film digitized to create the digital image data.

10. The computer-aided diagnosis system of claim 8 wherein the source of the digital image data is a digital imaging system.

11. The computer-aided diagnosis system of claim 8 wherein the source of the digital image data is a computer memory.

12. The computer-aided diagnosis system of claim 8 wherein the selected criteria includes a probability threshold where anatomical features suspected of having abnormalities at probability values above such threshold are identified.

13. The computer-aided diagnosis system of claim 8 wherein the plurality of pixels corresponding to said abnormal anatomical features are shown in a close-up view upon input from a user.

14. The computer-aided diagnosis system of claim 8 wherein at least one of said abnormal anatomical features is a calcification.

15. The computer-aided diagnosis system of claim 8 wherein the display further includes at least one marker rendered in said display identifying a location having a probability value above a probability value threshold.

16. The computer-aided diagnosis system of claim 15 wherein the probability value threshold is preselected.

17. The computer-aided diagnosis system of claim 15 wherein the probability value threshold is zero.

18. The computer-aided diagnosis system of claim 15 wherein marker information is displayed in a margin.

19. The computer-aided diagnosis system of claim 15 wherein marker information is presented in a display window.

20. The computer-aided diagnosis system of claim 8 wherein the display further includes a miniature map image.

21. The computer-aided diagnosis system of claim 20 wherein the miniature map image is storable.

22. The computer-aided diagnosis system of claim 20 wherein the miniature map image is annotated.

23. The computer-aided diagnosis system of claim 8 wherein the display further includes an annotated map.

24. The computer-aided diagnosis system of claim 23 wherein the annotated map includes at least one marker.

25. The computer-aided diagnosis system of claim 23 wherein the annotated map can be stored.

26. The computer-aided diagnosis system of claim 15 wherein marker information can be stored.

27. The computer-aided diagnosis system of claim 15 wherein information associated with at least one marker is displayed next to at least one said marker.

28. The computer-aided diagnosis system of claim 27 wherein the information includes probability values associated with at least one marker.

29. The computer-aided diagnosis system of claim 8 wherein the display includes digital image data associated with a first digital mammogram.

30. The computer-aided diagnosis system of claim 29 wherein the display further includes digital image data associated with a second digital mammogram.

31. The computer-aided diagnosis system of claim 29 wherein the second digital mammogram was taken at a time previous to said first digital mammogram.

32. The computer-aided diagnosis system of claim 29 wherein said first digital mammogram was obtained from x-ray film digitized to create digital image data.

33. The computer-aided diagnosis system of claim 15 wherein at least one said marker is displayed in a color associated with a probability value range.

34. The computer-aided diagnosis system of claim 15 wherein at least one said marker is displayed in a size proportional to the probability value.

35. The computer-aided diagnosis system of claim 15 wherein at least one said marker can be toggled on-off.

36. The computer-aided diagnosis system of claim 15 wherein a second threshold is provided.

37. The computer-aided diagnosis system of claim 36 wherein at least one marker having a probability value above said second threshold value is highlighted.

38. The computer-aided diagnosis system of claim 15 wherein a preset number of markers are displayed.

39. The computer-aided diagnosis system of claim 38 wherein the preset number is set by a user.

40. The computer-aided diagnosis system of claim 15 wherein the number of markers displayed does not exceed a preset number.

41. The computer-aided diagnosis system of claim 15 wherein the threshold can be varied by a control device.

42. The computer-aided diagnosis system of claim 8 wherein the display is touch sensitive.

43. The computer-aided diagnosis system of claim 8 wherein the display includes a wet read viewer.

44. The computer-aided diagnosis system of claim 8 wherein the pixels corresponding to said abnormal anatomical features are shown highlighted in a color different than non-abnormal anatomical features.

45. The computer-aided diagnosis system of claim 44 wherein the pixels corresponding to said anatomical features are white.

46. The computer-aided diagnosis system of claim 8 wherein the pixels corresponding to said abnormal anatomical features includes a display window displayed when at least one of said pixels is selected by a user.

47. The computer-aided diagnosis system of claim 46 wherein at least one of said pixels is selected by touch of the user.

48. The computer-aided diagnosis system of claim 46 wherein said display window includes information associated with highlighted abnormal anatomical features.

49. The computer-aided diagnosis system of claim 15 wherein said at least one marker is shown at a centroid of abnormal anatomical features.

50. The computer-aided diagnosis system of claim 49 wherein said at least one marker includes information related to abnormal anatomical features about the centroid.

51. The computer-aided diagnosis system of claim 8 wherein the pixels corresponding to said abnormal anatomical features are shown enlarged relative to pixels associated with non-abnormal anatomical features.

52. The computer-aided diagnosis system of claim 19 further comprising a display coupled with said processor for displaying digitized image data corresponding to at least one x-ray film, the display device further displaying the plurality of pixels corresponding to said abnormal anatomical features responsive to a command.

53. The computer-aided diagnosis system of claim 39 wherein the number of markers shown are those having the highest probability value.

54. The computer-aided diagnosis system of claim 8 wherein a source of digital image data is magnetic resonance imaging.

55. The computer-aided diagnosis system of claim 44 wherein the display displaying digital image data is printable on photographic film.

56. The computer-aided diagnosis system of claim 8 wherein the display further includes a breast outline.

57. The computer-aided diagnosis system of claim 56 wherein the breast outline can be toggled on-off.
